(19) United States
(12) Patent Application Publication
(10) Pub. No.: US 2013/0024647 A1
(43) Pub. Date: Jan. 24, 2013

(54) CACHE BACKED VECTOR REGISTERS

(71) Applicant: Darryl J. Gove, Sunnyvale, CA (US)

(72) Inventor: Darryl J. Gove, Sunnyvale, CA (US)

(21) Appl. No.: 13/187,148

(22) Filed: Jul. 20, 2011

(51) Int. Cl. G06F 12/10

(52) U.S. Cl. 711/207; 711/E12.061

(57) ABSTRACT

A processor, method, and medium for utilizing a shared cache to store vector registers. Each thread of a multithreaded processor utilizes a plurality of virtual vector registers to perform vector operations. Virtual vector registers are allocated for each thread, and each virtual vector register is mapped into the shared cache on the processor. The cache is shared between multiple threads such that if one thread is not using vector registers, there is more space in the cache for other threads to use vector registers.

### BACKGROUND OF THE INVENTION

1. Field of the Invention

The present invention relates generally to processors, and in particular to vector processors executing vector instructions.

2. Description of the Related Art

Modern computer processors typically achieve high throughput by utilizing multithreaded cores that simultaneously execute multiple threads. As used herein, a thread is a stream of instructions that is executed on a processor, and may commonly be referred to as a software thread. A thread may also refer to a hardware thread, wherein a hardware thread is exposed to the operating system by appearing to additional cores. A hardware thread may also refer to a thread context within a core, wherein a thread context includes, among other things, register files, extra instruction bits, and complex bypassing/forwarding logic.

Each software thread may include a set of instructions that execute independently of instructions from another software thread. For example, an individual software process, such as an application, may consist of one or more software threads that may be scheduled for parallel execution by an operating system. Threading can be an efficient way to improve processor throughput without increasing the processor die size. Multithreading may lead to more efficient use of processor resources and improved processor performance, as resources are less likely to sit idle with the threads operating in different stages of execution.

Another technique for achieving high throughput is to use a single instruction multiple data (SIMD) architecture to vectorize the data. In this manner, a single SIMD instruction may be performed on multiple data elements at the same time. A SIMD or vector execution unit typically includes multiple processing lanes that handle different vector elements and perform similar operations on all of the elements at the same time. For example, in an architecture that operates on four-element vectors, a SIMD or vector execution unit may include four processing lanes that perform the identical operations on the four elements in each vector.

Referring now to FIG. 1, a block diagram of one embodiment of a prior art vector processing unit is shown. Vector processing unit 140 includes four computing units 141-144. Computing units 141-144 operate on elements A-D, respectively, of source vector registers 110 and 120. Computing units 141-144 store the results of the vector operations in destination vector register 130. Generally speaking, a vector instruction may perform the same arithmetic or logical operation on a plurality of elements in one clock cycle.

The aforementioned techniques may also be combined, resulting in a multi-threaded vector execution unit architecture that enables multiple threads to issue SIMD instructions to one or more SIMD execution units to process multiple elements of multiple vectors at the same time. In one example, a vector register may be 16 bytes in length, and there may be 16 vector registers in the processor architecture. A vector register file containing the 16 vector registers may be 256 bytes in size. Processor cores may support multiple hardware threads, and each thread may require access to a vector register file. If there are eight threads sharing a processor core, then there may be 8*256=2 Kilobytes (KB) of space required for the corresponding vector register files. In other embodiments, there may be more than 16 vectors and the vectors may be larger than 16 bytes. A processor may also include more than eight threads, which may require an even greater allocation of area for the vector register files.

Typically, a small percentage of the vector registers will be constantly utilized in a processor executing vector code. It is unlikely that all threads will require all of the available vectors at the same time, and so many of the vector registers may sit idle for long stretches of time. Consequently, the number of active vectors on a core is typically much smaller than the allocated vector registers.

Therefore, a need exists in the art for a more efficient utilization of vector registers. In view of the above, improved methods and mechanisms for performing vector operations are desired.

### SUMMARY OF THE EMBODIMENTS OF THE INVENTION

Various embodiments of processors, methods, and mediums for allocating and utilizing virtual vector registers are contemplated. In one embodiment, a plurality of threads executing on a multithreaded processor may share virtual vector register storage space in the cache. To facilitate shared access amongst the plurality of threads, a mapping table may be maintained, wherein the mapping table may be configured to map virtual vector registers to locations within a cache. As part of executing a vector operation, a thread of the plurality of threads may access a virtual vector register. Responsive to detection of the access, it may be determined if the mapping table contains an entry for the virtual vector register being accessed. If the mapping table contains an entry for the virtual vector register, then the entry may be used to translate an address of the virtual vector register to an address of the corresponding cache line. The virtual vector register may be accessed using the translated address.

If the mapping table does not contain an entry for the virtual vector register, then a cache line may be allocated to store the virtual vector register. A mapping from the virtual vector register to the cache line may be created, and an entry with the mapping may be stored in the mapping table. Then the virtual vector register may be accessed by the thread. The above-recited steps may be repeated a plurality of times for a plurality of threads and a plurality of vector operations.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 is a block diagram that illustrates one embodiment of a prior art vector processor.

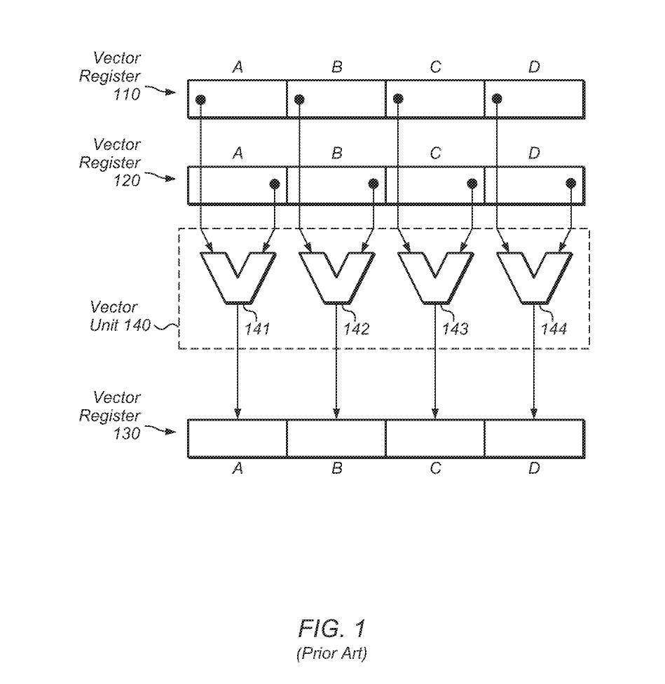

FIG. 2 is a block diagram that illustrates one embodiment of a multicore processor.

FIG. 3 is a block diagram that illustrates one embodiment of a processor core.

FIG. 4 illustrates a block diagram of a computer system in accordance with one or more embodiments.

FIG. 5 is a block diagram illustrating one embodiment of a multithreaded processor.

FIG. 6 is a block diagram illustrating one embodiment of a multicore processor.

FIG. 7 is a block diagram that illustrates one embodiment of multiple vector units coupled to a cache.

FIG. 8 is a generalized flow diagram illustrating one embodiment of a method for utilizing a cache in vector operations.

FIG. 9 is a block diagram illustrating one embodiment of a system including a processor.

### DETAILED DESCRIPTION

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A processing unit comprising a cache . . . ” Such a claim does not foreclose the processing unit from including additional components (e.g., a network interface, a crossbar).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

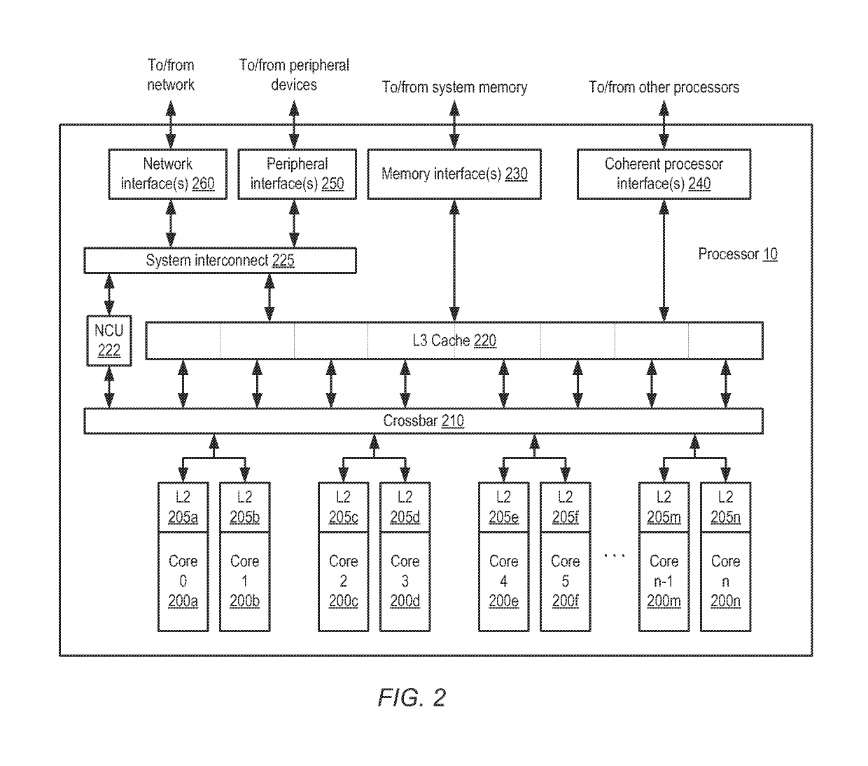

Referring now to FIG. 2, a block diagram illustrating one embodiment of a multithreaded processor is shown. In the illustrated embodiment, processor 10 includes a number of processor cores 200a-n, which are also designated “core 0” though “core n.” Various embodiments of processor 10 may include varying numbers of cores 200, such as 8, 16, or any other suitable number. Each of cores 200 is coupled to a corresponding L2 cache 205a-n, which in turn couple to L3 cache 220 via a crossbar 210. Cores 200a-n and L2 caches 205a-n may be generically referred to, either collectively or individually, as core(s) 200 and L2 cache(s) 205, respectively.

In one embodiment, a cache may be a high-speed array of recently accessed data or other computer information and is typically indexed by an address. Certain caches, like translation caches (also known as translation-lookaside buffers (TLBs)), can have two viable indices, such as a virtual address index (before translation) and a real address index (after translation). If such an array is indexed by one type of address (e.g., virtual address), but a search or update is required based on the other type of address (e.g., real address), a linear search of the array is typically required in order to determine any occurrence of the desired address (in this case, the real address).

Via crossbar 210 and L3 cache 220, cores 200 may be coupled to a variety of devices that may be located externally to processor 10. In the illustrated embodiment, one or more memory interface(s) 230 may be configured to couple to one or more banks of system memory (not shown). One or more coherent processor interface(s) 240 may be configured to couple processor 10 to other processors (e.g., in a multiprocessor environment employing multiple units of processor 10). Additionally, system interconnect 225 couples cores 200 to one or more peripheral interface(s) 250 and network interface(s) 260. As described in greater detail below, these interfaces may be configured to couple processor 10 to various peripheral devices and networks.

Cores 200 may be configured to execute instructions and to process data according to a particular instruction set architecture (ISA). In one embodiment, cores 200 may be configured to implement a version of the SPARC® ISA, such as SPARC® V9, UltraSPARC Architecture 2005, UltraSPARC Architecture 2007, or UltraSPARC Architecture 2009, for example. However, in other embodiments it is contemplated that any desired ISA may be employed, such as x86 (32-bit or 64-bit versions), PowerPC® or MIPS®, for example.

In the illustrated embodiment, each of cores 200 may be configured to operate independently of the others, such that all cores 200 may execute in parallel.

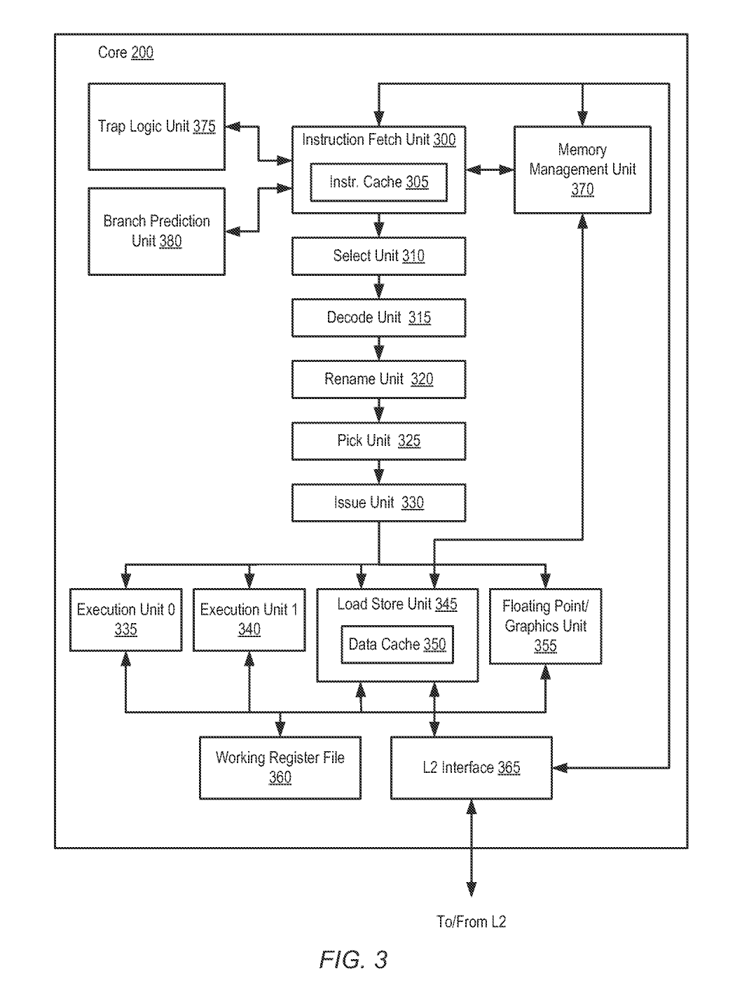

Additionally, as described below in conjunction with the description of FIG. 3, in some embodiments, each of cores 200 may be configured to execute multiple threads concurrently, where a given thread may include a set of instructions that may execute independently of instructions from another thread. For example, an individual software process, such as an application, may consist of one or more threads that may be scheduled for execution by an operating system. Such a core 200 may also be referred to as a multithreaded (MT) core. In one embodiment, each of cores 200 may be configured to concurrently execute instructions from a variable number of threads, up to eight concurrently executing threads. In a 16-core implementation, processor 10 could thus concurrently execute up to 128 threads. However, in other embodiments it is contemplated that other numbers of cores 200 may be provided, and that cores 200 may concurrently process different numbers of threads.

Additionally, as described in greater detail below, in some embodiments, each of cores 200 may be configured to execute certain instructions out of program order, which may also be referred to herein as out-of-order execution, or simply 000. As an example of out-of-order execution, for a particular thread, there may be instructions that are subsequent in program order to a given instruction yet do not depend on the given instruction. If execution of the given instruction is delayed for some reason (e.g., a cache miss), the later instructions may execute before the given instruction completes, which may improve overall performance of the executing thread.

As shown in FIG. 2, in one embodiment, each core 200 may have a dedicated corresponding L2 cache 205. In one embodiment, L2 cache 205 may be configured as a set-associative, writeback cache that is fully inclusive of first-level cache state (e.g., instruction and data caches within core 200). To maintain coherence with first-level caches, embodiments of L2 cache 205 may implement a reverse directory that maintains a virtual copy of the first-level cache tags. L2 cache 205 may implement a coherence protocol (e.g., the MESI protocol) to maintain coherence with other caches within processor 10. In one embodiment, L2 cache 205 may enforce a Total Store Ordering (TSO) model of execution in which all store instructions from the same thread must complete in program order.

In various embodiments, L2 cache 205 may include a variety of structures configured to support cache functionality and performance. For example, L2 cache 205 may include a miss buffer configured to store requests that miss the L2, a fill buffer configured to temporarily store data returning from L3 cache 220, a writeback buffer configured to temporarily store dirty evicted data and snoop copyback data, and/or a snoop buffer configured to store snoop requests received from L3 cache 220. In one embodiment, L2 cache 205 may implement a history-based prefetcher that may attempt to analyze L2 miss behavior and correspondingly generate prefetch requests to L3 cache 220.

Crossbar 210 may be configured to manage data flow between L2 caches 205 and the shared L3 cache 220. In one embodiment, crossbar 210 may include logic (such as multiplexers or a switch fabric, for example) that allows any L2 cache 205 to access any bank of L3 cache 220, and that allows data to be returned from any L3 bank to any L2 cache 205. That is, crossbar 210 may be configured as an M-to-N crossbar that allows for generalized point-to-point communication. However, in other embodiments, other interconnection schemes may be employed between L2 caches 205 and L3 cache 220. For example, a mesh, ring, or other suitable topology may be utilized.

Crossbar 210 may be configured to concurrently process data requests from L2 caches 205 to L3 cache 220 as well as data responses from L3 cache 220 to L2 caches 205. In some embodiments, crossbar 210 may include logic to queue data requests and/or responses, such that requests and responses may not block other activity while waiting for service. Additionally, in one embodiment crossbar 210 may be configured to arbitrate conflicts that may occur when multiple L2 caches 205 attempt to access a single bank of L3 cache 220, or vice versa.

L3 cache 220 may be configured to cache instructions and data for use by cores 200. In the illustrated embodiment, L3 cache 220 may be organized into eight separately addressable banks that may each be independently accessed, such that in the absence of conflicts, each bank may concurrently return data to a respective L2 cache 205. In some embodiments, each individual bank may be implemented using set-associative or direct-mapped techniques. For example, in one embodiment, L3 cache 220 may be an 8-megabyte (MB) cache, where each 1 MB bank is 16-way set associative with a 64-byte line size. L3 cache 220 may be implemented in some embodiments as a writeback cache in which written (dirty) data may not be written to system memory until a corresponding cache line is evicted. However, it is contemplated that in other embodiments, L3 cache 220 may be configured in any suitable fashion. For example, L3 cache 220 may be implemented with more or fewer banks, or in a scheme that does not employ independently accessible banks Also, L3 cache 220 may employ other bank sizes or cache geometries (e.g., different line sizes or degrees of set associativity). Furthermore, L3 cache 220 may employ write-through instead of writeback behavior. Still further, L3 cache 220 may or may not allocate on a write miss. Other variations of L3 cache 220 configurations are possible and contemplated.

In some embodiments, L3 cache 220 may implement queues for requests arriving from crossbar 210 and for results sent to crossbar 210. Additionally, in some embodiments L3 cache 220 may implement a fill buffer configured to store fill data arriving from memory interface 230, a writeback buffer configured to store dirty evicted data to be written to memory, and/or a miss buffer configured to store L3 cache accesses that cannot be processed as simple cache hits (e.g., L3 cache misses, cache accesses matching older misses, accesses such as atomic operations that may require multiple cache accesses, etc.). L3 cache 220 may variously be implemented as single-ported or multi-ported (i.e., capable of processing multiple concurrent read and/or write accesses). In either case, L3 cache 220 may implement arbitration logic to prioritize cache access among various cache read and write requestors.

Not all external accesses from cores 200 necessarily proceed through L3 cache 220. In the illustrated embodiment, non-cacheable unit (NCU) 222 may be configured to process requests from cores 200 for non-cacheable data, such as data from I/O devices as described below with respect to peripheral interface(s) 250 and network interface(s) 260.

Memory interface 230 may be configured to manage the transfer of data between L3 cache 220 and system memory, for example in response to cache fill requests and data evictions. In some embodiments, multiple instances of memory interface 230 may be implemented, with each instance configured to control a respective bank of system memory. Memory interface 230 may be configured to interface to any suitable type of system memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM (RDRAM®), for example. In some embodiments, memory interface 230 may be configured to support interfacing to multiple different types of system memory.

In the illustrated embodiment, processor 10 may also be configured to receive data from sources other than system memory. System interconnect 225 may be configured to provide a central interface for such sources to exchange data with cores 200, L2 caches 205, and/or L3 cache 220. In some embodiments, system interconnect 225 may be configured to coordinate Direct Memory Access (DMA) transfers of data to and from system memory. For example, via memory interface 230, system interconnect 225 may coordinate DMA transfers between system memory and a network device attached via network interface 260, or between system memory and a peripheral device attached via peripheral interface 250.

Processor 10 may be configured for use in a multiprocessor environment with other instances of processor 10 or other compatible processors. In the illustrated embodiment, coherent processor interface(s) 240 may be configured to implement high-bandwidth, direct chip-to-chip communication between different processors in a manner that preserves memory coherence among the various processors (e.g., according to a coherence protocol that governs memory transactions).

Peripheral interface 250 may be configured to coordinate data transfer between processor 10 and one or more peripheral devices. Such peripheral devices may include, for example and without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 250 may implement one or more instances of a standard peripheral interface. For example, one embodiment of peripheral interface 250 may implement the Peripheral Component Interface Express (PCI Express™ or PCIe) standard according to generation 1.x, 2.0, 3.0, or another suitable variant of that standard, with any suitable number of I/O lanes. However, it is contemplated that any suitable interface standard or combination of standards may be employed. For example, in some embodiments, peripheral interface 250 may be configured to implement a version of Universal Serial Bus (USB) protocol or IEEE 1394 (Firewire®) protocol in addition to or instead of PCI Express™.

Network interface 260 may be configured to coordinate data transfer between processor 10 and one or more network devices (e.g., networked computer systems or peripherals) coupled to processor 10 via a network. In one embodiment, network interface 260 may be configured to perform the data processing necessary to implement an Ethernet (IEEE 802.3) networking standard such as Gigabit Ethernet or 10-Gigabit Ethernet, for example. However, it is contemplated that any suitable networking standard may be implemented, including forthcoming standards such as 40-Gigabit Ethernet and 100-Gigabit Ethernet. In some embodiments, network interface 260 may be configured to implement other types of networking protocols, such as Fibre Channel, Fibre Channel over Ethernet (FCoE), Data Center Ethernet, Infiniband, and/or other suitable networking protocols. In some embodiments, network interface 260 may be configured to implement multiple discrete network interface ports.

As mentioned above, in one embodiment each of cores 200 may be configured for multithreaded, out-of-order execution. More specifically, in one embodiment, each of cores 200 may be configured to perform dynamic multithreading. Generally speaking, under dynamic multithreading, the execution resources of cores 200 may be configured to efficiently process varying types of computational workloads that exhibit different performance characteristics and resource requirements. Such workloads may vary across a continuum that emphasizes different combinations of individual-thread and multiple-thread performance.

At one end of the continuum, a computational workload may include a number of independent tasks, where completing the aggregate set of tasks within certain performance criteria (e.g., an overall number of tasks per second) is a more significant factor in system performance than the rate at which any particular task is completed. For example, in certain types of server or transaction processing environments, there may be a high volume of individual client or customer requests (such as web page requests or file system accesses). In this context, individual requests may not be particularly sensitive to processor performance. For example, requests may be I/O-bound rather than processor-bound—completion of an individual request may require I/O accesses (e.g., to relatively slow memory, network, or storage devices) that dominate the overall time required to complete the request, relative to the processor effort involved. Thus, a processor that is capable of concurrently processing many such tasks (e.g., as independently executing threads) may exhibit better performance on such a workload than a processor that emphasizes the performance of only one or a small number of concurrent tasks.

At the other end of the continuum, a computational workload may include individual tasks whose performance is highly processor-sensitive. For example, a task that involves significant mathematical analysis and/or transformation (e.g., cryptography, graphics processing, scientific computing) may be more processor-bound than I/O-bound. Such tasks may benefit from processors that emphasize single-task performance, for example through speculative execution and exploitation of instruction-level parallelism.

Dynamic multithreading represents an attempt to allocate processor resources in a manner that flexibly adapts to workloads that vary along the continuum described above. In one embodiment, cores 200 may be configured to implement fine-grained multithreading, in which each core may select instructions to execute from among a pool of instructions corresponding to multiple threads, such that instructions from different threads may be scheduled to execute adjacently. For example, in a pipelined embodiment of core 200 employing fine-grained multithreading, instructions from different threads may occupy adjacent pipeline stages, such that instructions from several threads may be in various stages of execution during a given core processing cycle. Through the use of fine-grained multithreading, cores 200 may be configured to efficiently process workloads that depend more on concurrent thread processing than individual thread performance.

In one embodiment, cores 200 may also be configured to implement out-of-order processing, speculative execution, register renaming and/or other features that improve the performance of processor-dependent workloads. Moreover, cores 200 may be configured to dynamically allocate a variety of hardware resources among the threads that are actively executing at a given time, such that if fewer threads are executing, each individual thread may be able to take advantage of a greater share of the available hardware resources. This may result in increased individual thread performance when fewer threads are executing, while retaining the flexibility to support workloads that exhibit a greater number of threads that are less processor-dependent in their performance. In various embodiments, the resources of a given core 200 that may be dynamically allocated among a varying number of threads may include branch resources (e.g., branch predictor structures), load/store resources (e.g., load/store buffers and queues), instruction completion resources (e.g., reorder buffer structures and commit logic), instruction issue resources (e.g., instruction selection and scheduling structures), register rename resources (e.g., register mapping tables), and/or memory management unit resources (e.g., translation lookaside buffers, page walk resources).

Turning now to FIG. 3, a block diagram of one embodiment of a processor core that may be configured to perform dynamic multithreading is illustrated. In the illustrated embodiment, core 200 includes an instruction fetch unit (IFU) 300 that includes an instruction cache 305. IFU 300 is coupled to a memory management unit (MMU) 370, L2 interface 365, trap logic unit (TLU) 375, and branch prediction unit 380. IFU 300 is additionally coupled to an instruction processing pipeline that begins with a select unit 310 and proceeds in turn through a decode unit 315, a rename unit 320, a pick unit 325, and an issue unit 330. Issue unit 330 is coupled to issue instructions to any of a number of instruction execution resources: an execution unit 0 (EXU0) 335, an execution unit 1 (EXU1) 340, a load store unit (LSU) 345 that includes a data cache 350, and/or a floating point/graphics unit (FGU) 355. These instruction execution resources are coupled to a working register file 360. Additionally, LSU 345 is coupled to L2 interface 365 and MMU 370. It is noted that the illustrated partitioning of resources is merely one example of how core 200 may be implemented. Alternative configurations and variations are possible and contemplated. Core 200 may practice all or part of the recited methods, may be a part of a computer system, and/or may operate according to instructions in non-transitory computer-readable storage media.

IFU 300 may be configured to provide instructions to the rest of core 200 for execution. In one embodiment, IFU 300 may be configured to select a thread to be fetched, fetch instructions from instruction cache 305 for the selected thread and buffer them for downstream processing, request data from L2 cache 205 in response to instruction cache misses, and receive information from branch prediction unit 380 regarding predictions of the direction and target of CTI's (e.g., branches). In some embodiments, IFU 300 may include a number of data structures in addition to instruction cache 305, such as an instruction translation lookaside buffer (ITLB), instruction buffers, and/or structures configured to store state that is relevant to thread selection and processing.

In one embodiment, during each execution cycle of core 200, IFU 300 may be configured to select one thread that will enter the IFU processing pipeline. Thread selection may take into account a variety of factors and conditions, some thread-specific and others IFU-specific. For example, certain instruction cache activities (e.g., cache fill), ITLB activities, or diagnostic activities may inhibit thread selection if these activities are occurring during a given execution cycle. Additionally, individual threads may be in specific states of readiness that affect their eligibility for selection. For example, a thread for which there is an outstanding instruction cache miss may not be eligible for selection until the miss is resolved. In some embodiments, those threads that are eligible to participate in thread selection may be divided into groups by priority, for example depending on the state of the thread or of the ability of the IFU pipeline to process the thread. In such embodiments, multiple levels of arbitration may be employed to perform thread selection. Selection may occur first by group priority, and then within the selected group according to a suitable arbitration algorithm (e.g., a least-recently-fetched algorithm). However, it is noted that any suitable scheme for thread selection may be employed, including arbitration schemes that are more complex or simpler than those mentioned here.

Once a thread has been selected for fetching by IFU 300, instructions may actually be fetched for the selected thread. To perform the fetch, in one embodiment, IFU 300 may be configured to generate a fetch address to be supplied to instruction cache 305. In various embodiments, the fetch address may be generated as a function of a program counter associated with the selected thread, a predicted branch target address, or an address supplied in some other manner (e.g., through a test or diagnostic mode). The generated fetch address may then be applied to instruction cache 305 to determine whether there is a cache hit.

In some embodiments, accessing instruction cache 305 may include performing fetch address translation (e.g., in the case of a physically indexed and/or tagged cache), accessing a cache tag array, and comparing a retrieved cache tag to a requested tag to determine cache hit status. If there is a cache hit, IFU 300 may store the retrieved instructions within buffers for use by later stages of the instruction pipeline. If there is a cache miss, IFU 300 may coordinate retrieval of the missing cache data from L2 cache 205. In some embodiments, IFU 300 may also be configured to prefetch instructions into instruction cache 305 before the instructions are actually required to be fetched. For example, in the case of a cache miss, IFU 300 may be configured to retrieve the missing data for the requested fetch address as well as addresses that sequentially follow the requested fetch address, on the assumption that the following addresses are likely to be fetched in the near future.

In many ISAs, instruction execution proceeds sequentially according to instruction addresses (e.g., as reflected by one or more program counters). However, control transfer instructions (CTIs) such as branches, call/return instructions, or other types of instructions may cause the transfer of execution from a current fetch address to a nonsequential address. Branch prediction unit 380 may be configured to predict the direction and target of CTIs (or, in some embodiments, a subset of the CTIs that are defined for an ISA) in order to reduce the delays incurred by waiting until the effect of a CTI is known with certainty. In one embodiment, branch prediction unit 380 may be configured to implement a perceptron-based dynamic branch predictor, although any suitable type of branch predictor may be employed. In some embodiments, IFU 300 may implement the functionality of branch prediction unit 380.

To implement branch prediction, branch prediction unit 380 may implement a variety of control and data structures in various embodiments, such as history registers that track prior branch history, weight tables that reflect relative weights or strengths of predictions, and/or target data structures that store fetch addresses that are predicted to be targets of a CTI. Also, in some embodiments, IFU 300 may further be configured to partially decode (or predecode) fetched instructions in order to facilitate branch prediction. A predicted fetch address for a given thread may be used as the fetch address when the given thread is selected for fetching by IFU 300. The outcome of the prediction may be validated when the CTI is actually executed (e.g., if the CTI is a conditional instruction, or if the CTI itself is in the path of another predicted CTI). If the prediction was incorrect, instructions along the predicted path that were fetched and issued may be cancelled.

By predicting return addresses for fetched return instructions, processor core 200, in many instances, may be able to achieve greater instruction throughput than other multithreaded processor cores because core 200 may begin fetching instructions using a predicted return address instead of stalling while a return instruction executes and its return address is retrieved.

Through the operations discussed above, IFU 300 may be configured to fetch and maintain a buffered pool of instructions from one or multiple threads, to be fed into the remainder of the instruction pipeline for execution. Generally speaking, select unit 310 may be configured to select and schedule threads for execution. In one embodiment, during any given execution cycle of core 200, select unit 310 may be configured to select up to one ready thread out of the maximum number of threads concurrently supported by core 200 (e.g., 8 threads), and may select up to two instructions from the selected thread for decoding by decode unit 315, although in other embodiments, a differing number of threads and instructions may be selected. In various embodiments, different conditions may affect whether a thread is ready for selection by select unit 310, such as branch mispredictions, unavailable instructions, or other conditions. To ensure fairness in thread selection, some embodiments of select unit 310 may employ arbitration among ready threads (e.g. a least-recently-used algorithm).

The particular instructions that are selected for decode by select unit 310 may be subject to the decode restrictions of decode unit 315. Thus, in any given cycle, fewer than the maximum possible number of instructions may be selected. Additionally, in some embodiments, select unit 310 may be configured to allocate certain execution resources of core 200 to the selected instructions, so that the allocated resources will not be used for the benefit of another instruction until they are released. For example, select unit 310 may allocate resource tags for entries of a reorder buffer, load/store buffers, or other downstream resources that may be utilized during instruction execution.

Generally, decode unit 315 may be configured to prepare the instructions selected by select unit 310 for further processing. Decode unit 315 may be configured to identify the particular nature of an instruction (e.g., as specified by its opcode) and to determine the source and sink (i.e., destination) registers encoded in an instruction, if any. In some embodiments, decode unit 315 may be configured to detect certain dependencies among instructions, to remap architectural registers to a flat register space, and/or to convert certain complex instructions to two or more simpler instructions for execution. Additionally, in some embodiments, decode unit 315 may be configured to assign instructions to slots for subsequent scheduling. In one embodiment, two slots 0-1 may be defined, where slot 0 includes instructions executable in load/store unit 345 or execution units 335-340, and where slot 1 includes instructions executable in execution units 335-340, floating point/graphics unit 355, and any branch instructions. However, in other embodiments, other numbers of slots and types of slot assignments may be employed, or slots may be omitted entirely.

Register renaming may facilitate the elimination of certain dependencies between instructions (e.g., write-after-read or “false” dependencies), which may in turn prevent unnecessary serialization of instruction execution. In one embodiment, rename unit 320 may be configured to rename the logical (i.e., architected) destination registers specified by instructions by mapping them to a physical register space, resolving false dependencies in the process. In some embodiments, rename unit 320 may maintain mapping tables that reflect the relationship between logical registers and the physical registers to which they are mapped.

Once decoded and renamed, instructions may be ready to be scheduled for execution. In the illustrated embodiment, pick unit 325 may be configured to pick instructions that are ready for execution and send the picked instructions to issue unit 330. In one embodiment, pick unit 325 may be configured to maintain a pick queue that stores a number of decoded and renamed instructions as well as information about the relative age and status of the stored instructions. During each execution cycle, this embodiment of pick unit 325 may pick up to one instruction per slot. For example, taking instruction dependency and age information into account, for a given slot, pick unit 325 may be configured to pick the oldest instruction for the given slot that is ready to execute.

In some embodiments, pick unit 325 may be configured to support load/store speculation by retaining speculative load/store instructions (and, in some instances, their dependent instructions) after they have been picked. This may facilitate replaying of instructions in the event of load/store misspeculation. Additionally, in some embodiments, pick unit 325 may be configured to deliberately insert “holes” into the pipeline through the use of stalls, e.g., in order to manage downstream pipeline hazards such as synchronization of certain load/store or long-latency FGU instructions.

Issue unit 330 may be configured to provide instruction sources and data to the various execution units for picked instructions. In one embodiment, issue unit 330 may be configured to read source operands from the appropriate source, which may vary depending upon the state of the pipeline. For example, if a source operand depends on a prior instruction that is still in the execution pipeline, the operand may be bypassed directly from the appropriate execution unit result bus. Results may also be sourced from register files representing architectural (i.e., user-visible) as well as non-architectural state. In the illustrated embodiment, core 200 includes a working register file 360 that may be configured to store instruction results (e.g., integer results, floating point results, and/or condition code results) that have not yet been committed to architectural state, and which may serve as the source for certain operands. The various execution units may also maintain architectural integer, floating-point, and condition code state from which operands may be sourced.

Instructions issued from issue unit 330 may proceed to one or more of the illustrated execution units for execution. In one embodiment, each of EXU0 335 and EXU1 340 may be similarly or identically configured to execute certain integer-type instructions defined in the implemented ISA, such as arithmetic, logical, and shift instructions. In the illustrated embodiment, EXU0 335 may be configured to execute integer instructions issued from slot 0, and may also perform address calculation for load/store instructions executed by LSU 345. EXU1 340 may be configured to execute integer instructions issued from slot 1, as well as branch instructions. In one embodiment, FGU instructions and multi-cycle integer instructions may be processed as slot 1 instructions that pass through the EXU1 340 pipeline, although some of these instructions may actually execute in other functional units.

In some embodiments, architectural and non-architectural register files may be physically implemented within or near execution units 335-340. It is contemplated that in some embodiments, core 200 may include more or fewer than two integer execution units, and the execution units may or may not be symmetric in functionality. Also, in some embodiments, execution units 335-340 may not be bound to specific issue slots, or may be differently bound than just described.

LSU 345 may be configured to process data memory references, such as integer and floating-point load and store instructions and other types of memory reference instructions. LSU 345 may include a data cache 350 as well as logic configured to detect data cache misses and to responsively request data from an L2 cache via L2 interface 365. In one embodiment, data cache 350 may be configured as a set-associative, write-through cache in which all stores are written to an L2 cache regardless of whether they hit in data cache 350. As noted above, the actual computation of addresses for load/store instructions may take place within one of the integer execution units, though in other embodiments, LSU 345 may implement dedicated address generation logic. In some embodiments, LSU 345 may implement an adaptive, history-dependent hardware prefetcher configured to predict and prefetch data that is likely to be used in the future, in order to increase the likelihood that such data will be resident in data cache 350 when it is needed.

In various embodiments, LSU 345 may implement a variety of structures configured to facilitate memory operations. For example, LSU 345 may implement a data translation lookaside buffer (TLB) to cache virtual data address translations, as well as load and store buffers configured to store issued but not-yet-committed load and store instructions for the purposes of coherency snooping and dependency checking LSU 345 may include a miss buffer configured to store outstanding loads and stores that cannot yet complete, for example due to cache misses. In one embodiment, LSU 345 may implement a store queue configured to store address and data information for stores that have committed, in order to facilitate load dependency checking LSU 345 may also include hardware configured to support atomic load-store instructions, memory-related exception detection, and read and write access to special-purpose registers (e.g., control registers).

Floating point/graphics unit (FGU) 355 may be configured to execute and provide results for certain floating-point and graphics-oriented instructions defined in the implemented ISA. For example, in one embodiment FGU 355 may implement single- and double-precision floating-point arithmetic instructions compliant with the IEEE 754-1985 floating-point standard, such as add, subtract, multiply, divide, and certain transcendental functions. Also, in one embodiment FGU 355 may implement partitioned-arithmetic and graphics-oriented instructions defined by a version of the SPARC® Visual Instruction Set (VIS™) architecture, such as VIS™ 2.0 or VIS™ 3.0. In some embodiments, FGU 355 may implement fused and unfused floating-point multiply-add instructions. Additionally, in one embodiment FGU 355 may implement certain integer instructions such as integer multiply, divide, and population count instructions. Depending on the implementation of FGU 355, some instructions (e.g., some transcendental or extended-precision instructions) or instruction operand or result scenarios (e.g., certain denormal operands or expected results) may be trapped and handled or emulated by software.

In one embodiment, FGU 355 may implement separate execution pipelines for floating point add/multiply, divide/square root, and graphics operations, while in other embodiments the instructions implemented by FGU 355 may be differently partitioned. In various embodiments, instructions implemented by FGU 355 may be fully pipelined (i.e., FGU 355 may be capable of starting one new instruction per execution cycle), partially pipelined, or may block issue until complete, depending on the instruction type. For example, in one embodiment floating-point add and multiply operations may be fully pipelined, while floating-point divide operations may block other divide/square root operations until completed.

Embodiments of FGU 355 may also be configured to implement hardware cryptographic support. For example, FGU 355 may include logic configured to support encryption/decryption algorithms such as Advanced Encryption Standard (AES), Data Encryption Standard/Triple Data Encryption Standard (DES/3DES), the Kasumi block cipher algorithm, and/or the Camellia block cipher algorithm. FGU 355 may also include logic to implement hash or checksum algorithms such as Secure Hash Algorithm (SHA-1, SHA-256, SHA-384, SHA-512), or Message Digest 5 (MD5). FGU 355 may also be configured to implement modular arithmetic such as modular multiplication, reduction and exponentiation, as well as various types of Galois field operations. In one embodiment, FGU 355 may be configured to utilize the floating-point multiplier array for modular multiplication. In various embodiments, FGU 355 may implement several of the aforementioned algorithms as well as other algorithms not specifically described.

The various cryptographic and modular arithmetic operations provided by FGU 355 may be invoked in different ways for different embodiments. In one embodiment, these features may be implemented via a discrete coprocessor that may be indirectly programmed by software, for example by using a control word queue defined through the use of special registers or memory-mapped registers. In another embodiment, the ISA may be augmented with specific instructions that may allow software to directly perform these operations.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. For example, in an embodiment employing 4 MB pages, a 64-bit virtual address and a 40-bit physical address, 22 address bits (corresponding to 4 MB of address space, and typically the least significant address bits) may constitute the page offset. The remaining 42 bits of the virtual address may correspond to the virtual page number of that address, and the remaining 18 bits of the physical address may correspond to the physical page number of that address. In such an embodiment, virtual to physical address translation may occur by mapping a virtual page number to a particular physical page number, leaving the page offset unmodified.

Such translation mappings may be stored in an ITLB or a DTLB for rapid translation of virtual addresses during lookup of instruction cache 305 or data cache 350. In the event no translation for a given virtual page number is found in the appropriate TLB, memory management unit 370 may be configured to provide a translation. In one embodiment, MMU 370 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk or a hardware table walk.) In some embodiments, if MMU 370 is unable to derive a valid address translation, for example if one of the memory pages including a necessary page table is not resident in physical memory (i.e., a page miss), MMU 370 may be configured to generate a trap to allow a memory management software routine to handle the translation. It is contemplated that in various embodiments, any desirable page size may be employed. Further, in some embodiments multiple page sizes may be concurrently supported.

As noted above, several functional units in the illustrated embodiment of core 200 may be configured to generate off-core memory requests. For example, IFU 300 and LSU 345 each may generate access requests to an L2 cache in response to their respective cache misses. Additionally, MMU 370 may be configured to generate memory requests, for example while executing a page table walk. In the illustrated embodiment, L2 interface 365 may be configured to provide a centralized interface to the L2 cache associated with a particular core 200, on behalf of the various functional units that may generate L2 accesses. In one embodiment, L2 interface 365 may be configured to maintain queues of pending L2 requests and to arbitrate among pending requests to determine which request or requests may be conveyed to the L2 cache during a given execution cycle. For example, L2 interface 365 may implement a least-recently-used or other algorithm to arbitrate among L2 requestors. In one embodiment, L2 interface 365 may also be configured to receive data returned from the L2 cache, and to direct such data to the appropriate functional unit (e.g., to data cache 350 for a data cache fill due to miss).

During the course of operation of some embodiments of core 200, exceptional events may occur. For example, an instruction from a given thread that is selected for execution by select unit 310 may not be a valid instruction for the ISA implemented by core 200 (e.g., the instruction may have an illegal opcode), a floating-point instruction may produce a result that requires further processing in software, MMU 370 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit (TLU) 375 may be configured to manage the handling of such events. For example, TLU 375 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 375 may be configured to flush all instructions from the trapping thread from any stage of processing within core 200, without disrupting the execution of other, non-trapping threads. In some embodiments, when a specific instruction from a given thread causes a trap (as opposed to a trap-causing condition independent of instruction execution, such as a hardware interrupt request), TLU 375 may implement such traps as precise traps. That is, TLU 375 may ensure that all instructions from the given thread that occur before the trapping instruction (in program order) complete and update architectural state, while no instructions from the given thread that occur after the trapping instruction (in program order) complete or update architectural state.

Additionally, in the absence of exceptions or trap requests, TLU 375 may be configured to initiate and monitor the commitment of working results to architectural state. For example, TLU 375 may include a reorder buffer (ROB) that coordinates transfer of speculative results into architectural state. TLU 375 may also be configured to coordinate thread flushing as a result of branch misprediction. For instructions that are not flushed or otherwise cancelled due to mispredictions or exceptions, instruction processing may end when instruction results have been committed.

In various embodiments, any of the units illustrated in FIG. 3 may be implemented as one or more pipeline stages, to form an instruction execution pipeline that begins when thread fetching occurs in IFU 300 and ends with result commitment by TLU 375. Depending on the manner in which the functionality of the various units of FIG. 3 is partitioned and implemented, different units may require different numbers of cycles to complete their portion of instruction processing. In some instances, certain units (e.g., FGU 355) may require a variable number of cycles to complete certain types of operations.

Through the use of dynamic multithreading, in some instances, it is possible for each stage of the instruction pipeline of core 200 to hold an instruction from a different thread in a different stage of execution, in contrast to conventional processor implementations that typically require a pipeline flush when switching between threads or processes. In some embodiments, flushes and stalls due to resource conflicts or other scheduling hazards may cause some pipeline stages to have no instruction during a given cycle. However, in the fine-grained multithreaded processor implementation employed by the illustrated embodiment of core 200, such flushes and stalls may be directed to a single thread in the pipeline, leaving other threads undisturbed. Additionally, even if one thread being processed by core 200 stalls for a significant length of time (for example, due to an L2 cache miss), instructions from another thread may be readily selected for issue, thus increasing overall thread processing throughput.

As described previously, however, the various resources of core 200 that support fine-grained multithreaded execution may also be dynamically reallocated to improve the performance of workloads having fewer numbers of threads. Under these circumstances, some threads may be allocated a larger share of execution resources while other threads are allocated correspondingly fewer resources. Even when fewer threads are sharing comparatively larger shares of execution resources, however, core 200 may still exhibit the flexible, thread-specific flush and stall behavior described above.

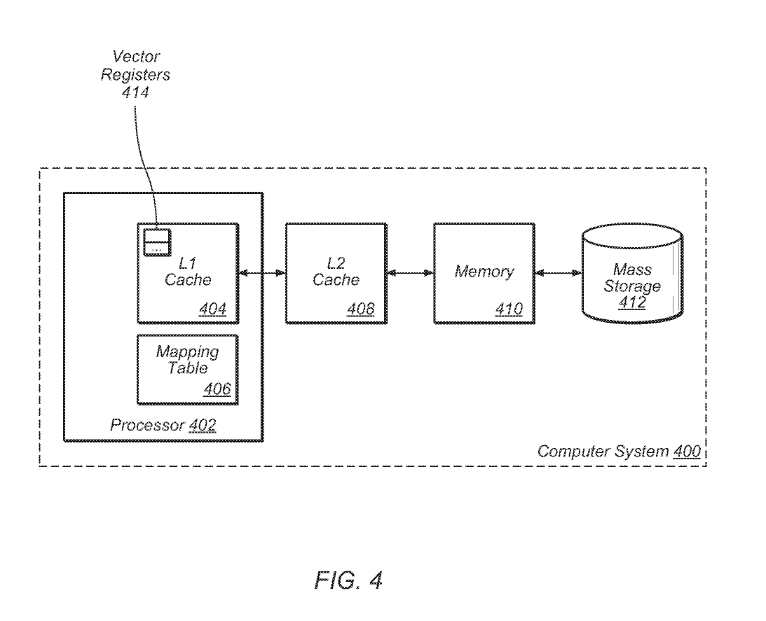

Turning now to FIG. 4, a block diagram of one embodiment of a computer system is shown. Computer system 400 may include, among other components, processor 402, L1 cache 404, mapping table 406, L2 cache 408, memory 410, and mass storage 412. Processor 402 is representative of any number of processors which may be included in computer system 400. It is noted that processor 402 may include components and perform functions described previously in regard to processor 10 (of FIG. 2). In various embodiments, processor 402 may be a general-purpose processor that performs computational operations. For example, processor 402 may be a central processing unit (CPU), such as a microprocessor. Alternatively, processor 402 may be a controller or an application-specific integrated circuit.

Processor 402 may include one or more cores (not shown), and the one or more cores may be coupled to L1 cache 404. Additionally, each of the one or more cores of processor 402 may be configured to execute multiple threads. In one embodiment, processor 402 may be configured to execute SIMD vector instructions. L1 cache 404 may be configured to store vector registers 414 which are representative of any number of vector registers. Processor 402 may also store mapping table 406, which may be configured to map virtual vector registers to locations within L1 cache 404.

Generally speaking, instead of allocating a separate space for a vector register file (i.e., an array of vector registers 414), the vector register file may be stored in L1 cache 404. When a thread needs to use a vector register, the thread may store the vector register in L1 cache 404, and then the thread may fetch the vector register from L1 cache 404. While the thread is executing vector code, the vector register may be stored in a cache line in L1 cache 404. When the thread has finished executing vector code, the cache line may be reused by another thread. Typically, all of the threads will not be executing vector code at the same time, and so the cache may be shared by all of the threads without impacting the performance of processor 402.

When processor 402 executes an instruction to load data into a vector register, processor 402 may actually be dealing with a virtual vector register that is mapped onto L1 cache 404. The result of a load register instruction may be a load of data into the L1 cache 404. The operation may include manipulating a cache structure rather than directly manipulating registers. This operation may result in additional latency, but the vector instructions are typically long latency operations, so the additional latency may have minimal impact on the overall latency of the instruction.

Vector registers 414 may be shared by any number of threads executing on any number of cores on processor 402. If a vector register is no longer required or needed by a thread, the cache line storing the vector register may be evicted to L2 cache 408. L2 cache 408 may be part of the memory subsystem, and L2 cache 408 may be coupled to memory 410. Memory 410 is representative of any number and type of storage devices, and memory 410 may be coupled to mass storage 412. Mass storage 412 is also representative of any number and type of storage devices. In one embodiment, mass storage 412 may be a backup storage device. In other embodiments, other storage devices, such as a level three (L3) cache, may be part of the memory subsystem.

Mass-storage device 412, memory 410, L2 cache 408, and L1 cache 404 are non-transitory computer-readable storage devices that collectively form a memory hierarchy that stores data and instructions for processor 402. Generally, mass-storage device 412 may be a high-capacity, non-volatile storage device, such as a disk drive or a large flash memory, with a large access time, while L1 cache 404, L2 cache 408, and memory 410 may be smaller, faster semiconductor memories that store copies of frequently used data. Memory 410 may be a dynamic random access memory (DRAM) structure that is larger than L1 cache 404 and L2 cache 408, whereas L1 cache 404 and L2 cache 408 may be comprised of smaller static random access memories (SRAM).

Computer system 400 may be incorporated into many different types of electronic devices. For example, computer system 400 may be part of a desktop computer, a laptop computer, a server, a media player, an appliance, a cellular phone, testing equipment, a network appliance, a calculator, a personal digital assistant (PDA), a smart phone, a guidance system, a control system (e.g., an automotive control system), or another electronic device.

In alternative embodiments, different components than those shown in FIG. 4 may be present in computer system 400. For example, computer system 400 may include video cards, network cards, optical drives, and/or other peripheral devices that are coupled to processor 402 using a bus, a network, or another suitable communication channel. Alternatively, computer system 400 may include one or more additional processors, wherein the processors share some or all of L2 cache 408, memory 410, and mass-storage device 412. On the other hand, computer system 400 may not include some of the memory hierarchy (i.e., L2 cache 408, memory 410, and/or mass-storage device 412).

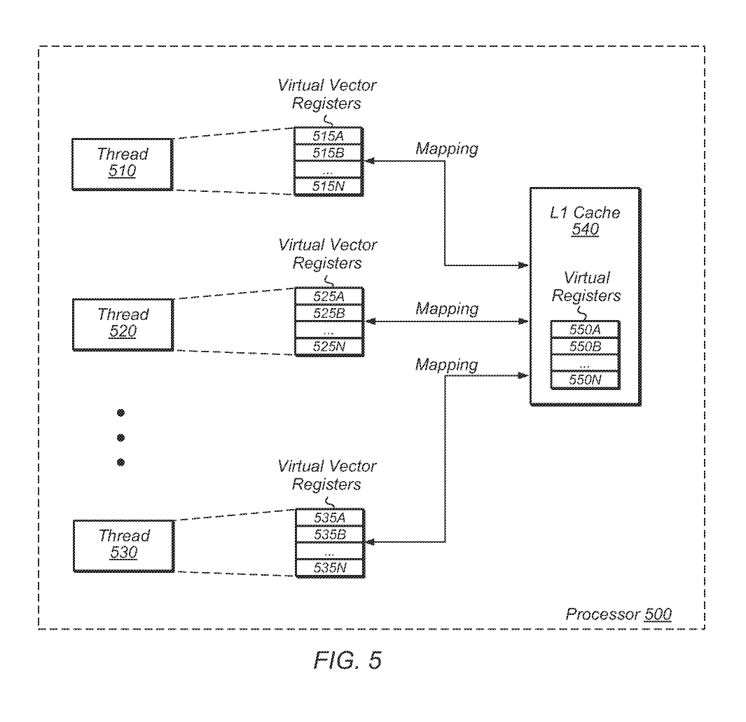

Referring now to FIG. 5, a block diagram illustrating a mapping of virtual vector registers to a cache is shown. Processor 500 may include one or more cores (not shown) and threads 510, 520, and 530 may execute on the one or more cores of processor 500. Threads 510-530 are representative of any number of threads which may execute on processor 500. Thread 510 may utilize virtual vector registers 515A-N, thread 520 may utilize virtual vector registers 525A-N, and thread 530 may utilize virtual vector registers 535A-N. The virtual vector registers may be dynamically allocated in real-time for each thread. Each set of virtual vector registers 515, 525, and 535 are representative of any number of virtual vector registers. Also, each set of virtual vector registers 515-535 may be mapped to L1 cache 540. In one embodiment, L1 cache 540 may be allocated exclusively for storing the data of virtual vector registers 515-535.

Each thread may reference virtual vector registers when performing vector operations. A virtual vector register that is being referenced by a thread may be an index into L1 cache 540. In one embodiment, the virtual vector registers 515-535 may be mapped to L1 cache 540 via an index or an indirection table. In another embodiment, virtual vector registers 515-535 may be mapped to L1 cache 540 with the use of a content addressable memory (CAM). In a further embodiment, another type of table or index may be used to map virtual vector registers 515-535 to L1 cache 540. L1 cache 540 may allocate and deallocate storage in contiguous blocks referred to as cache lines, such that a cache line may be the minimum unit of allocation/deallocation of storage space in the L1 cache 540. L1 cache 540 may include a plurality of virtual registers 550A-N for storing data associated with virtual vector registers 515-535. In various embodiments, the space allocated for virtual registers 550A-N in L1 cache 540 may be smaller than the number of virtual vector registers 515-535 allocated for threads 510-530.

In one embodiment, 256 virtual vector registers may be allocated to each thread 510-530. If there are 64 threads operating on processor 500, then a total of 16,384 virtual vector registers may be allocated for processor 500. However, these virtual registers may be mapped to L1 cache 540 such that permanent space for the total number of registers (16,384) may not be required. Typically, a small percentage of the virtual registers 515-535 may be used at the same time, and so a smaller number of virtual registers 550A-N may be used for storing data for virtual vector registers 515-535 that are actively being used.

In other embodiments, other quantities of virtual vector registers 515-535 may be allocated to each thread of threads 510-530. In general, there is no limit to the number of virtual registers 515-535 which may be allocated to a thread, to a core, or to processor 500 as a whole. Virtual registers 515-535 may be allocated without utilizing any actual hardware resources. In this way, a thread may never run out of vector registers because large numbers of virtual vector registers may be allocated to the thread.

In various embodiments, a thread may utilize a plurality of virtual vector registers for a section of vector instructions, and then after executing this section of instructions, the thread may begin executing a section of scalar code. At this point, the thread may notify L1 cache 540 that the thread no longer needs the vector registers stored in L1 cache 540. At this point, L1 cache 540 may evict the data in cache lines corresponding to the thread's virtual vector registers, and L1 cache 540 may mark indicators or tags associated with the corresponding virtual vector registers to indicate that the registers may now be utilized by other threads. When another thread needs to use a virtual vector register, the other thread may utilize one or more of the registers that were being used by the original thread.

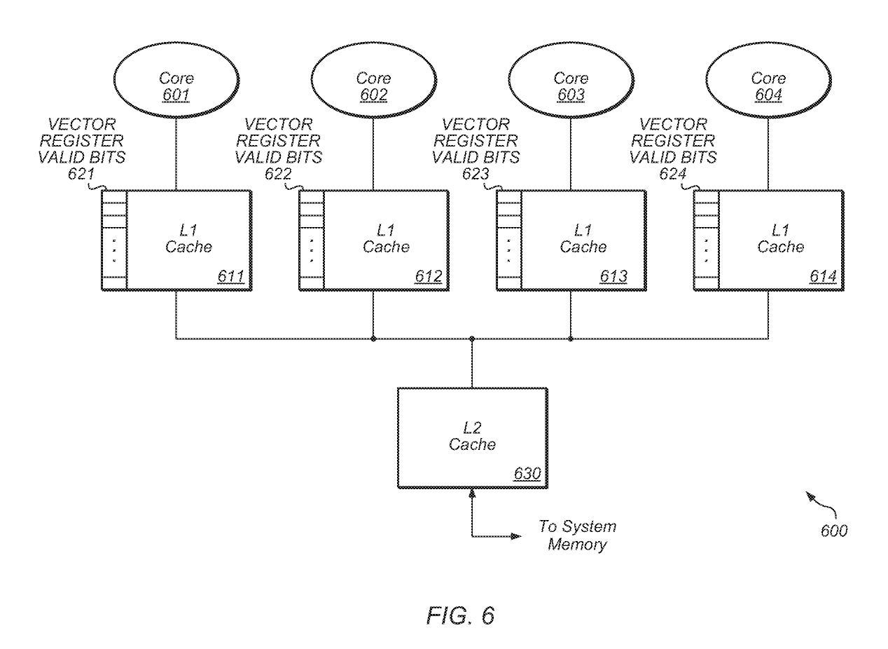

Referring now to FIG. 6, a block diagram illustrating one embodiment of a multi-core processor is shown. The multi-core processor 600 includes a number of cores 601-604 which are coupled to Level One (L1) caches 611-614, respectively. Cores 601-604 are representative of any number of cores which may be included in processor 600. Each core may be coupled to its own, separate L1 cache for storing vector registers. In one embodiment, each L1 cache 611-614 may store only vector registers. In another embodiment, each L1 cache 611-614 may store vector registers and other data. Each L1 cache 611-614 may include a set of vector register valid bits 621-624, respectively, to indicate whether the vector registers should be stored to memory if they are evicted from the respective L1 cache. The vector register valid bits 621-624 may also indicate if a respective vector register should be fetched from memory the next time the vector register is read. The L1 caches 611-614 are coupled to L2 cache 630, and L2 cache 630 is coupled to system memory (not shown). In various embodiments, each vector register may be mapped to a cache line via a content addressable memory (CAM), an indirection table, or another index. A first virtual vector register may be mapped to a first cache line of the cache, a second virtual vector register may be mapped to a second cache line of the cache, and so on.

When a vector register is utilized, a cache line may be allocated in the L1 cache for the register. The allocation of the cache line may require an eviction of another cache line. In one embodiment, a thread may indicate to the L1 cache when the vector register is no longer needed. If the vector register is no longer needed for vector operations, then the register may be evicted from the L1 cache. In another embodiment, the L1 cache may determine when to evict the vector register. For example, the vector register valid bits may indicate whether or not the vector register should be stored in the L2 cache if the vector register is evicted from the L1 cache.

The L1 and L2 cache memories may be significantly faster than DRAM memory, and may augment the function of data storage provided by the main system memory. For example, L2 cache 630 may be coupled externally to the processor 600 and L1 caches 611-614 may be coupled internally with processor 600, and these cache memories may be significantly faster than a main system memory implemented utilizing DRAM technology. L1 and L2 cache memories may be implemented utilizing, for example, static random access memory (SRAM) technology, which may be approximately two to three times faster than DRAM technology.

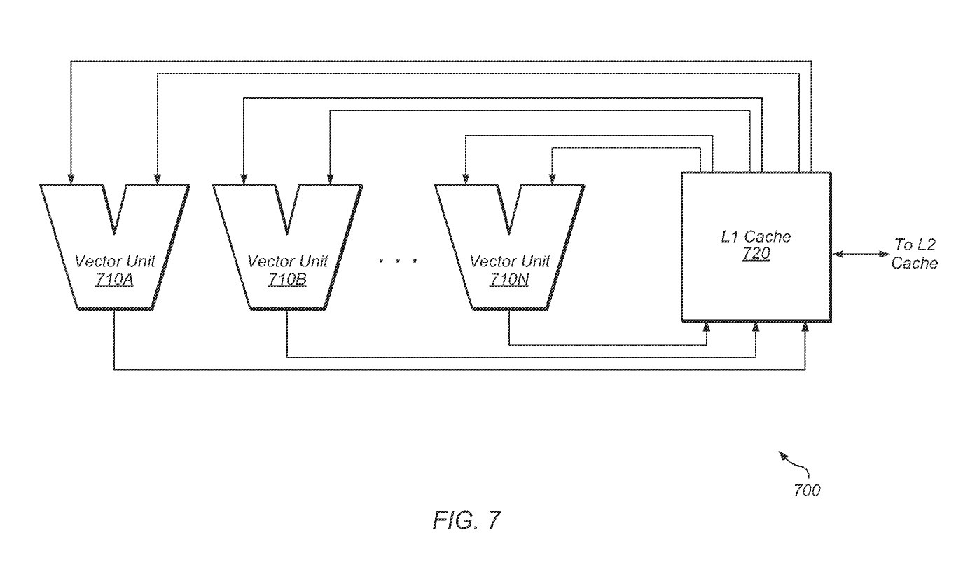

Turning now to FIG. 7, a block diagram of one embodiment of multiple vector units accessing a cache is shown. Vector units 710A, 710B, and 710N are representative of any number of vector execution units which may share a common L1 cache 720 for storing vector registers. Vector units 710A-N may load vector registers from L1 cache 720 at the beginning of a vector operation, and then store the output of the vector operation to cache 720 at the conclusion of the vector operation. L1 cache 720 may be coupled to an L2 cache (not shown), such that vector registers which are evicted from L1 cache 720 may be stored in the L2 cache. Alternatively, vector registers which are evicted from L1 cache 720 may be stored in memory (not shown).

Each of vector units 710A-N may be utilized by a plurality of threads. Each thread may require access to a vector register file to support SIMD vector operations. By using a cache to store the vector register file, all of the threads may have space available to hold vector registers. Threads that are not currently using vector registers may yield space in L1 cache 720 to threads that are actively using vector registers. The use of L1 cache 720 may minimize power consumption of the processor and maximize utilization of space in the cache for vector registers.

When a thread uses a vector register, space is allocated in the cache for the register. When the vector register is no longer required or used by the thread, the register value may be evicted to a lower level of cache (e.g., L2 cache) or to memory, and then the freed up space may be used by another vector register. The use of the cache may reduce the amount of space required to support vector registers for the plurality of threads of a multithreaded vector processor. In other embodiments, other types of registers (e.g., integer, floating point) may be stored in L1 cache 720 instead of being stored in a separately allocated register file. The methods and mechanisms described herein for use with vector registers may also be utilized with integer registers, floating point registers, and other types of registers.

In another embodiment, a small number of physical vector registers may be utilized in combination with L1 cache 720. The instruction set (e.g., VIS instruction set) may implement a large number of virtual vector registers and a small number of physical vector registers. For example, eight physical vector registers may be utilized, such that if a thread uses only eight vector registers, the accesses to the registers may be to actual physical vector registers. If a thread uses any additional registers beyond the first eight then the additional registers may be stored in L1 cache 720. In other embodiments, other numbers of physical vector registers may be utilized.

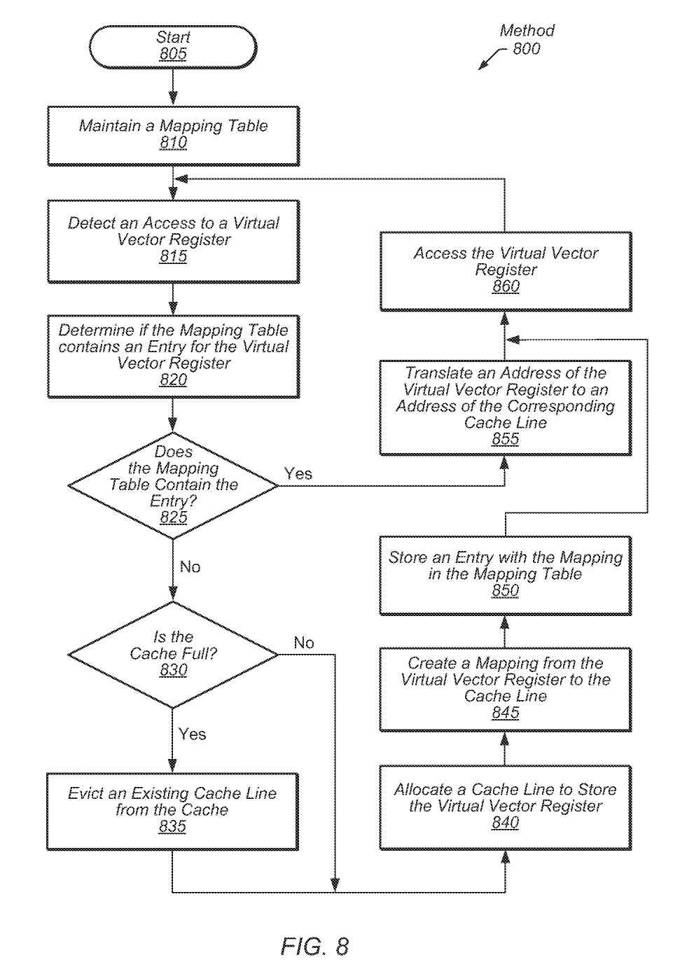

Referring now to FIG. 8, one embodiment of a method for utilizing virtual vector registers is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired.

Method 800 starts in block 805, and then a mapping table may be maintained (block 810). The mapping table may be configured to map virtual vector registers to locations within a cache. In various embodiments, the mapping table may be a CAM, indirection table, or other index or table. In one embodiment, the cache may be a L1 cache. Next, an access to a virtual vector register may be detected (block 815). The access may be initiated by any of a plurality of threads executing on a multithreaded processor. The plurality of threads may share virtual vector register storage space in the cache. To access a virtual vector register, each thread may refer to the virtual vector register in a similar manner to how a thread would refer to an actual physical vector register.

Next, responsive to the detection of the access, it may be determined if the mapping table contains an entry for the virtual vector register being accessed (block 820).

If the mapping table contains an entry for the virtual vector register (conditional block 825), then the entry may be used to translate an address of the virtual vector register to an address of the corresponding cache line (block 855). After block 855, the virtual vector register may be accessed using the translated address (block 860). If the mapping table does not contains an entry for the virtual vector register (conditional block 825), then it may be determined if the cache is full (block 830).

If the cache is full (conditional block 830), then an existing cache line may be evicted from the cache (block 835). In one embodiment, the evicted cache line may be stored in a L2 cache. After block 835, a cache line may be allocated to store the virtual vector register (block 840). If the cache is not full (conditional block 830), then a cache line may be allocated to store the virtual vector register (block 840). After block 840, a mapping from the virtual vector register to the cache line may be created (block 845). Then, an entry with this mapping may be stored in the mapping table (block 850). After block 850, the virtual vector register may be accessed by the thread (block 860). After block 860, method 800 may return to block 815 to detect the next access to a virtual vector register. In various embodiments, if a virtual vector register is no longer needed, a thread may clear a valid bit corresponding to the virtual vector register to indicate the register does not need to be stored to memory if it is evicted from the cache.

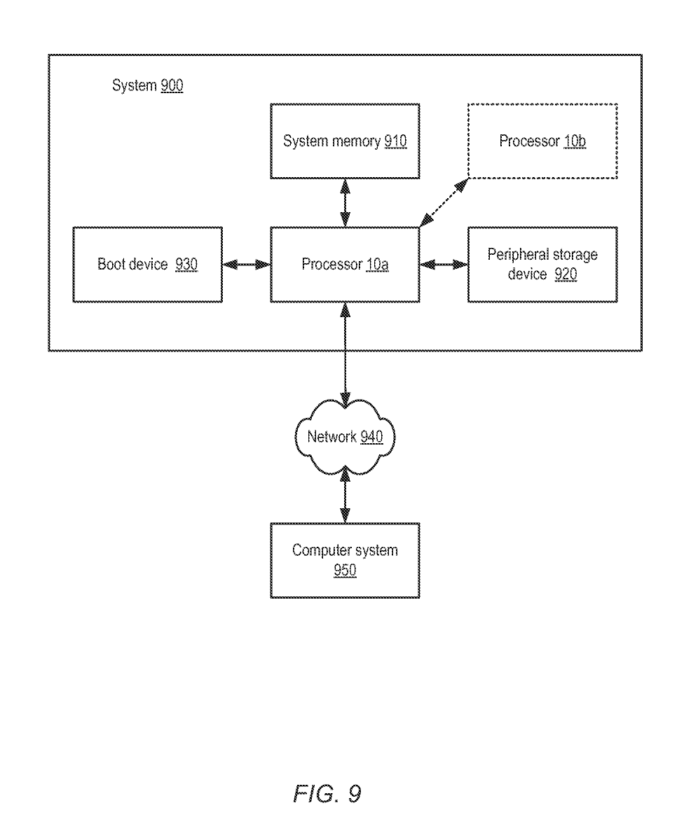

Referring now to FIG. 9, a block diagram of one embodiment of a system including a processor is shown. In the illustrated embodiment, system 900 includes an instance of processor 10, shown as processor 10a, that is coupled to a system memory 910, a peripheral storage device 920, and a boot device 930. System 900 is coupled to a network 940, which is in turn coupled to another computer system 950. In some embodiments, system 900 may include more than one instance of the devices shown. In various embodiments, system 900 may be configured as a rack-mountable server system, a standalone system, or in any other suitable form factor. In some embodiments, system 900 may be configured as a client system rather than a server system.

In some embodiments, system 900 may be configured as a multiprocessor system, in which processor 10a may optionally be coupled to one or more other instances of processor 10, shown in FIG. 9 as processor 10b. For example, processors 10a-b may be coupled to communicate via their respective coherent processor interfaces.

In various embodiments, system memory 910 may comprise any suitable type of system memory as described above, such as FB-DIMM, DDR/DDR2/DDR3/DDR4 SDRAM, or RDRAM®, for example. System memory 910 may include multiple discrete banks of memory controlled by discrete memory interfaces in embodiments of processor 10 that provide multiple memory interfaces. Also, in some embodiments, system memory 910 may include multiple different types of memory.

Peripheral storage device 920, in various embodiments, may include support for magnetic, optical, or solid-state storage media such as hard drives, optical disks, nonvolatile RAM devices, etc. In some embodiments, peripheral storage device 920 may include more complex storage devices such as disk arrays or storage area networks (SANs), which may be coupled to processor 10 via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processor 10, such as multimedia devices, graphics/display devices, standard input/output devices, etc. In one embodiment, peripheral storage device 920 may be coupled to processor 10 via peripheral interface(s) 250 of FIG. 2.

In one embodiment, boot device 930 may include a device such as an FPGA or ASIC configured to coordinate initialization and boot of processor 10, such as from a power-on reset state. Additionally, in some embodiments boot device 930 may include a secondary computer system configured to allow access to administrative functions such as debug or test modes of processor 10.

Network 940 may include any suitable devices, media and/or protocol for interconnecting computer systems, such as wired or wireless Ethernet, for example. In various embodiments, network 940 may include local area networks (LANs), wide area networks (WANs), telecommunication networks, or other suitable types of networks. In some embodiments, computer system 950 may be similar to or identical in configuration to illustrated system 900, whereas in other embodiments, computer system 950 may be configured in a substantially different manner. For example, computer system 950 may be a server system, a processor-based client system, a stateless “thin” client system, a mobile device, etc. In some embodiments, processor 10 may be configured to communicate with network 940 via network interface(s) 260 of FIG. 2.

It is noted that the above-described embodiments may comprise software. In such an embodiment, program instructions and/or a database (both of which may be referred to as “instructions”) that represent the described systems and/or methods may be stored on a computer readable storage medium. Generally speaking, a computer readable storage medium may include any non-transitory storage media accessible by a computer during use to provide instructions and/or data to the computer. For example, a computer readable storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM)), ROM, non-volatile memory (e.g. Flash memory) accessible via a peripheral interface such as the USB interface, etc. Storage media may include micro-electro-mechanical systems (MEMS), as well as storage media accessible via a communication medium such as a network and/or a wireless link.

Although several embodiments of approaches have been shown and described, it will be apparent to those of ordinary skill in the art that a number of changes, modifications, or alterations to the approaches as described may be made. Changes, modifications, and alterations should therefore be seen as within the scope of the methods and mechanisms described herein. It should also be emphasized that the above-described embodiments are only non-limiting examples of implementations.

What is claimed is:

1. A method comprising:
maintaining a mapping table, wherein the mapping table is configured to map virtual vector registers to locations within a cache;
detecting a first access to a first virtual vector register by a first thread;
allocating a first cache line in the cache to store the first virtual vector register responsive to said detection;
creating a given mapping of the first virtual vector register to the first cache line; and
storing the given mapping within an entry of the mapping table.

2. The method as recited in claim 1, further comprising:
detecting a second access to a second virtual vector register by a second thread;
responsive to determining the mapping table contains an entry for the second virtual vector register, translating an address of the second virtual vector register to an address of the corresponding cache line using the entry for the second virtual vector register;
responsive to determining the mapping table does not contain an entry for the second virtual vector register:
evicting an existing cache line from the cache, responsive to determining the cache is full;
allocating a second cache line for the second virtual vector register; and
creating a mapping of the second virtual vector register to the second cache line and storing the mapping of the second virtual vector register within an entry of the mapping table.

3. The method as recited in claim 2, wherein each of the first and second virtual vector registers comprises a plurality of data elements.

4. The method as recited in claim 2, wherein N elements of virtual vector registers are allocated for a plurality of threads and M elements are allocated in the cache for virtual vector registers, wherein N and M are integers and N is greater than M.

5. The method as recited in claim 2, wherein the cache is a level one (L1) cache.

6. The method as recited in claim 5, the method further comprising storing the existing cache line in a level two (L2) cache subsequent to evicting the existing cache line from the L1 cache.

7. The method as recited in claim 5, wherein responsive to determining a valid bit corresponding to the existing cache line is not set, the method further comprising discarding the existing cache line subsequent to evicting the existing cache line from the L1 cache.

8. A processor comprising:
one or more vector execution units, wherein the one or more vector execution units are configured to execute a plurality of threads; and
one or more level one (L1) caches;
wherein the processor is configured to:
maintain a mapping table, wherein the mapping table is configured to map virtual vector registers to locations within a L1 cache;
detect a first access to a first virtual vector register by a first thread;
allocate a first cache line in the L1 cache to store the first virtual vector register responsive to said detection;
create a given mapping of the first virtual vector register to the first cache line; and
store the given mapping within an entry of the mapping table.

9. The processor as recited in claim 8, wherein the processor is further configured to:
detect a second access to a second virtual vector register by a second thread;
responsive to determining the mapping table contains an entry for the second virtual vector register, translate an address of the second virtual vector register to an address of the corresponding cache line using the entry for the second virtual vector register;
responsive to determining the mapping table does not contain an entry for the second virtual vector register:
evict an existing cache line from the cache, responsive to determining the L1 cache is full;
allocate a second cache line for the second virtual vector register; and
create a mapping of the second virtual vector register to the second cache line and storing the mapping of the second virtual vector register within an entry of the mapping table.

10. The processor as recited in claim 9, wherein each of the first and second virtual vector registers comprises a plurality of data elements.

11. The processor as recited in claim 9, wherein N elements of virtual vector registers are allocated for the plurality of threads and M elements are allocated in the one or more L1 caches for virtual vector registers, wherein N and M are integers and N is greater than M.

12. The processor as recited in claim 9, wherein the processor is further configured to store the existing cache line in a level two (L2) cache subsequent to evicting the existing cache line from the L1 cache.

13. The processor as recited in claim 9, wherein responsive to determining a valid bit corresponding to the existing cache line is not set, the processor is further configured to discard the existing cache line subsequent to evicting the existing cache line from the L1 cache.

14. A computer readable storage medium comprising program instructions, wherein when executed the program instructions are operable to:
maintain a mapping table, wherein the mapping table is configured to map virtual vector registers to locations within a cache;
detect a first access to a first virtual vector register by a first thread;
allocate a first cache line in the cache to store the first virtual vector register responsive to said detection;
create a given mapping of the first virtual vector register to the first cache line; and
store the given mapping within an entry of the mapping table.

15. The computer readable storage medium as recited in claim 14, wherein the program instructions are further operable to:
detect a second access to a second virtual vector register by a second thread;
responsive to determining the mapping table contains an entry for the second virtual vector register, translate an address of the second virtual vector register to an address of the corresponding cache line using the entry for the second virtual vector register;
responsive to determining the mapping table does not contain an entry for the second virtual vector register:
evict an existing cache line from the cache, responsive to determining the cache is full;
allocate a second cache line for the second virtual vector register; and
create a mapping of the second virtual vector register to the second cache line and storing the mapping of the second virtual vector register within an entry of the mapping table.

16. The computer readable storage medium as recited in claim 15, wherein each of the first and second virtual vector registers comprises a plurality of data elements.

17. The computer readable storage medium as recited in claim 15, wherein N elements of virtual vector registers are allocated for a plurality of threads, wherein M elements are allocated in the cache for virtual vector registers, and wherein N and M are integers and N is greater than M.

18. The computer readable storage medium as recited in claim 15, wherein the cache is a level one (L1) cache.

19. The computer readable storage medium as recited in claim 18, wherein the program instructions are further operable to store the existing cache line in a level two (L2) cache subsequent to evicting the existing cache line from the L1 cache.

20. The computer readable storage medium as recited in claim 18, wherein responsive to determining a valid bit corresponding to the existing cache line is not set, the program instructions are further operable to discard the existing cache line subsequent to evicting the existing cache line from the L1 cache.
